(19) United States
(12) Patent Application Publication
(10) Pub. No.: US 2002/0188817 A1
(43) Pub. Date: Dec. 12, 2002

(54) Store buffer pipeline

(76) Inventors: Erik K. Norden, Santa Clara, CA (US); Klaus J. Oberlaender, San Jose, CA (US); Andrew Addison, Bristol (GB)

Correspondence Address: BEVER HOFFMAN & HARMS, LLP, 2099 GATEWAY PLACE, SUITE 320, SAN JOSE, CA, 951101017

(21) Appl. No.: 09/877,704

(22) Filed: Jun. 8, 2001

(51) Int. Cl. G06F 12/00

(52) U.S. Cl. 711/169

(57) ABSTRACT

A load/store pipeline uses a store buffer pipeline to avoid data dependency issues and resource conflicts. Store instructions are stored in the store buffer pipeline. During processing of a later store instruction, the stored instruction stores data into the memory system. Specifically the stored store instruction stores data during the same load/store pipeline stage that a load instruction would read data from the memory system. Thus, memory resource conflicts caused by a store instruction followed by a load instruction are avoided. Some embodiments of the present invention includes N store buffer stages so that a first store instruction is not carried out until the (N+1)th store instruction is processed. The delay provided by the store buffer pipeline can be used to process information regarding the store instruction such as cache hits or misses and store cancellation instructions.

### FIELD OF THE INVENTION

The present invention relates to pipelined processing systems, and more particularly to a method and apparatus for improving performances of a pipeline and simplification of a pipeline by using store buffers.

### BACKGROUND OF THE INVENTION

Modern computer systems utilize a variety of different microprocessor architectures to perform program execution. Each microprocessor architecture is configured to execute programs made up of a number of macro instructions and micro instructions. Many macro instructions are translated or decoded into a sequence of micro instructions before processing. Micro instructions are simple machine instructions that can be executed directly by a microprocessor.

To increase processing power, most microprocessors use multiple pipelines, such as an integer pipeline and a load/store pipeline to process the macro and micro instructions. Typically, each pipeline consists of multiple stages. Each stage in a pipeline operates in parallel with the other stages. However, each stage operates on a different macro or micro instruction. Pipelines are usually synchronous with respect to the system clock signal. Therefore, each pipeline stage is designed to perform its function in a single clock cycle. Thus, the instructions move through the pipeline with each active clock edge of a clock signal.

FIG. 1 shows an instruction fetch and issue unit, having an instruction fetch stage (I stage) 105 and a pre-decode stage (PD stage) 110, coupled to a typical four stage integer pipeline 120 for a microprocessor. Integer pipeline 120 comprises a decode stage (D stage) 130, an execute one stage (E1 stage) 140, an execute two stage (E2 stage) 150, and a write back stage (W stage) 160. Instruction fetch stage 105 fetches instructions to be processed. Pre-decode stage 110 groups and issues instructions to one or more pipelines. Ideally, instructions are issued into integer pipeline 120 every clock cycle. Each instruction passes through the pipeline and is processed by each stage as necessary. Thus, during ideal operating conditions integer pipeline 120 is simultaneously processing 4 instructions. However, many conditions as explained below may prevent the ideal operation of integer pipeline 120.

Decode stage 130 decodes the instruction and gathers the source operands needed by the instruction being processed in decode stage 130. Execute one stage 140 and execute two stage 150 performs the function of the instructions. Write back stage 160 writes the appropriate result value into the register file. Pipeline 120 can be enhanced by including forwarding paths between the various stages of integer pipeline 120 as well as forwarding paths between various stages of other pipelines. For brevity and clarity forwarding paths, which is well known in the art, is not described in detail herein.

FIG. 2 shows a typical four stage load/store pipeline 200 for a microprocessor coupled to a memory system 270, instruction fetch stage 105 and pre-decode stage 110. Load/store pipeline 200 includes a decode stage (D stage) 230, an execute one stage (E1 stage) 340, an execute two stage (E2 stage) 250, and a write back stage (W stage) 260. In one embodiment, memory system 270 includes a data cache 274 and main memory 278. Other embodiments of memory system 270 may be configured as scratch pad memory using SPAMs. Because memory systems, data caches, and scratch pad memories, are well known in the art, the function and performance of memory system 270 is not described in detail. Load/store pipeline 200 is specifically tailored to perform load and store instructions. By including both a load/store pipeline and an integer pipeline, overall performance of a microprocessor is enhanced because the load/store pipeline and integer pipelines can perform in parallel. Decode stage 230 decodes the instruction and reads the register file (not shown) for the needed information regarding the instruction. Execute one stage 240 calculates memory addresses for the load or store instructions. Because the address is calculated in execute one stage and load instructions only require the address, execute one state 240 configures memory system 270 to provide the appropriate data at the next active clock cycle for load from memory. However, for store instructions, the data to be stored is typically not available at execute one stage 240. For load instructions, execute two stage 250 retrieves information from the appropriate location in memory system 270, the register file, or another pipeline stage. For store instructions, execute two stage 250 prepares to write the data appropriate location. For example, for stores to memory, execute two stage 250 configures memory system 270 to store the data on the next active clock edge. For register load operations, write back stage 260 writes the appropriate value into a register file.

Ideally, integer pipeline 120 and load/store pipeline 200 can execute instructions every clock cycle. However, many situations may occur that causes parts of integer pipeline 120 or load/store pipeline 200 to stall, which degrades the performance of the microprocessor. A common problem which causes pipeline stalls is latency in memory system 270 caused by cache misses. For example, a store instruction “ST [A0], DO” stores data from data register 0 into address A0 of memory system 270. If the value for address A0 is in a data cache 274, the value in data register D0 can simply replace the data value for address A0 in data cache 274. However, if the value for address A0 is not in data cache 274 and data cache 274 is full, the value from data register D0 can not be placed into data cache 274 until space in the data cache is freed by copying a value from data cache 274 into a main memory 278. Thus, memory system 270 may cause load/store pipeline 200 to stall as the cache miss is written back and/or re-filled.

Another cause of pipeline stalls are data coherency problems between instructions in the pipeline. For example, if instruction “ST [A0], D0” is followed by “LD D1, [A0]”, which means to load data register D1 with the value at memory address A0, “LD D1, [A0]” can not be executed until after “ST [A0],D0” is complete. Otherwise, “LD D1, [A0]” may load an outdated value in the data register D1. Many data dependency problems can be solved by forwarding data between pipeline stages. However, in many pipelines forwarding between some stages can not be accomplished because the required data in the stage forwarding the data is not available until late in the clock cycle. Thus, the stage requiring the forwarded data can not process the forwarded data in the remaining clock cycle.

Resource contention is another cause of pipeline stalls. As explained above generally a load instruction uses memory system 270 in execute two stage 250 and a store instruction uses memory system 270 in write back stage 260. If a store instruction is followed by a load instruction in load/store pipeline 200, the store instruction would be processed in write back stage 260 at the same time that the load instruction is processed by execute two stage 250. Thus, both execute two stage 250 and write back stage 260 requires the use of memory system 270 to finish processing the instructions. Because, memory system 270 generally can not be used for reading and writing simultaneously, a pipeline stall occurs.

Hence there is a need for a method or system to resolve data dependency problems and resource conflicts to minimize the number of pipeline stalls.

### SUMMARY

Accordingly, a load/store pipeline in accordance with on embodiment of the present invention includes a store buffer pipeline, which can be used to delay actual memory access to avoid data dependency issues and resource conflicts. For example, in one embodiment of the present invention, a memory loading and storing system uses a store buffer pipeline with a load/store pipeline to read and write from a memory system. The store buffer pipeline can contain one or more store buffer stages. The final store buffer stage is coupled to the memory system. Some embodiments of the present invention includes bypass paths which are coupled between the memory system and other store buffer stages. Information regarding a first store instruction are stored in the store buffer pipeline. Specifically, in one embodiment of the present invention, a store buffer stage includes a data portion, an address portion, and a write byte enable portion to store the data, addresses, and write byte enables of a store instruction. When a second store instruction is processed through the load/store pipeline the data from the first store instruction is written into the memory system at the appropriate memory address.

Specifically, when the second store instruction is in the first load/store stage, the memory system is configured so that at the next active edge of the system clock signal, the data from the first load instruction is written into the memory system. In embodiments of the present invention using N store buffer stages, the data from a first store instruction is usually not written into the memory system until the active clock edge after the (N+1)th store instruction is processed in the first load/store pipeline stage. By configuring the load/store pipeline to execute memory reads at the active clock edge after a load instruction is processed in the first load/store pipeline stage, memory resource conflicts can be avoided even when store instructions are followed by load instructions.

The present invention will be more fully understood in view of the following description and drawings.

### BRIEF DESCRIPTION OF THE DRAWINGS

FIG. 1 is simplified diagram of a conventional integer pipeline.

FIG. 2 is simplified diagram of a conventional load/store pipeline.

FIG. 3 is a simplified diagram of a load/store pipeline with a store buffer pipeline in accordance with one embodiment of the present invention.

FIG. 4 is simplified diagram of a store buffer pipeline in accordance with one embodiment of the present invention.

FIGS. 5(a)-5(f) illustrate the performance of an load/store pipeline with a store buffer pipeline in accordance with one embodiment of the present invention.

FIGS. 6(a)-6(d) illustrate the performance of an load/store pipeline with a store buffer pipeline in accordance with one embodiment of the present invention.

FIGS. 7(a)-7(g) illustrate the performance of an load/store pipeline with a store buffer pipeline in accordance with one embodiment of the present invention.

FIGS. 8(a)-8(e) illustrate the performance of an load/store pipeline with a store buffer pipeline in accordance with one embodiment of the present invention.

FIGS. 9(a)-9(f) illustrate the performance of an load/store pipeline with a store buffer pipeline in accordance with one embodiment of the present invention.

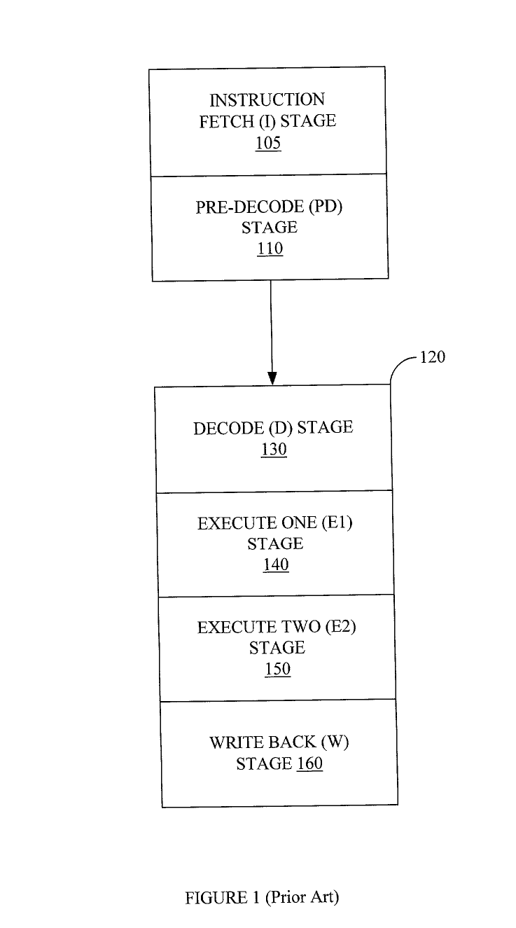

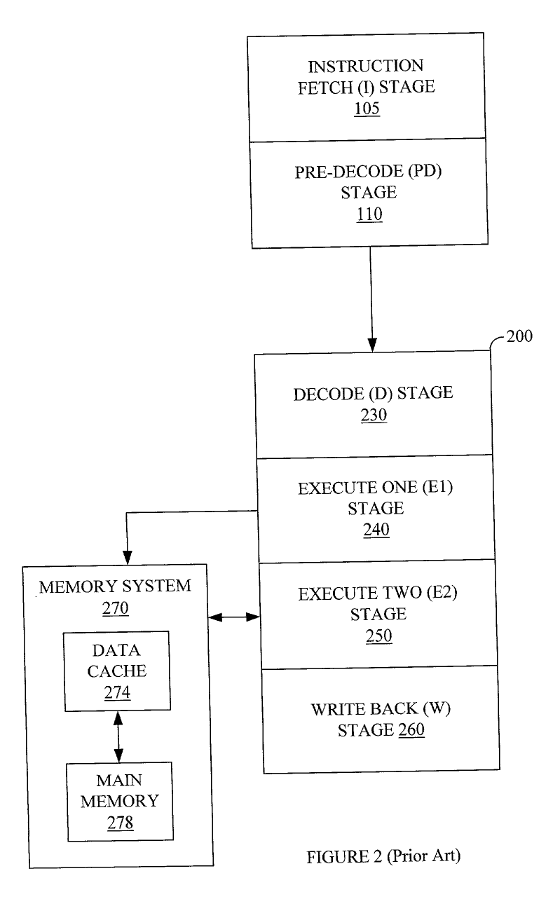

### DETAILED DESCRIPTION

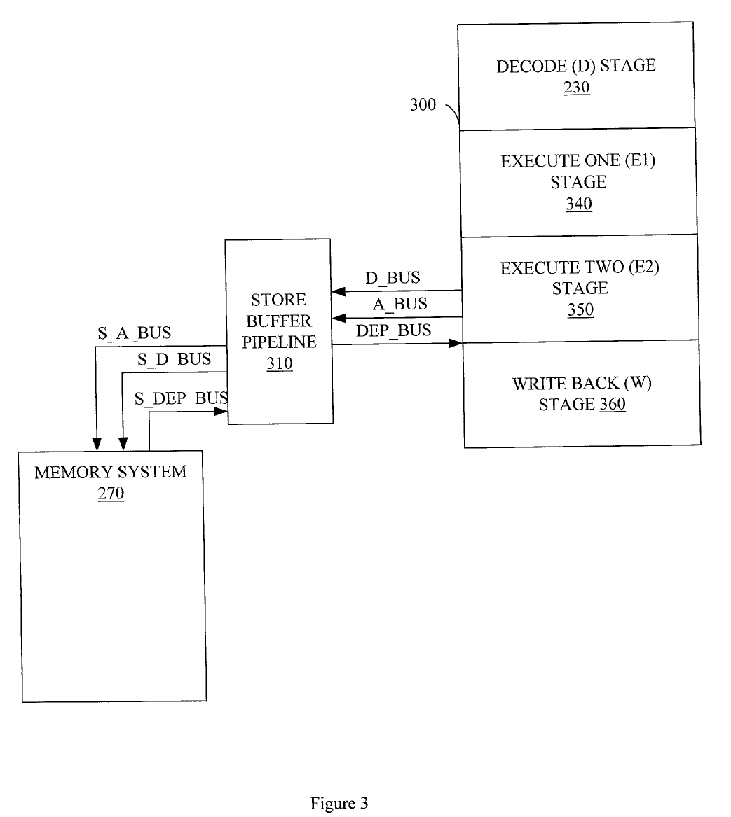

FIG. 3 is a simplified block diagram of a load/store pipeline 300, with a store buffer pipeline 310 and memory system 270 in accordance with one embodiment of the present invention. Load/store pipeline 300 receives instructions from instruction fetch stage 105 (not shown in FIG. 3) and pre-decode stage 110 (also not shown in FIG. 3). Load/store pipeline 300 includes decode stage 230, execute one stage 340, execute two stage 350, write back stage 360. Store instructions are processed through load/store pipeline 300 using store buffer pipeline 310, which is coupled between load/store pipeline 300 and memory system 270. Specifically, an addresses bus A_BUS is used to transfer addresses from various stages of load/store pipeline 300 to store buffer pipeline 310. Similarly, a store buffer address bus S_A_BUS is used to transfer addresses from store buffer pipeline 310 to memory system 270. A data bus D_BUS transfer data from the various stages of load/store pipeline 300 to store buffer 310. Similarly, a store buffer data bus S_D_BUS is used to transfer data from buffer pipeline 310 to memory system 270. In some embodiments a dependency bus DEP BUS is used to transfer data from store buffer pipeline 310 to load/store pipeline 300. Similarly, in some embodiments, a dependency bus S_DEP_BUS is used to transfer data from memory system 270 to store buffer pipeline 310. Generally, multiplexers are used to interconnect the many busses in the various pipelines. To avoid unnecessary complexity, the multiplexers used to interconnect the various busses are omitted in the figures. One skilled in the art, can use the teachings provided herein to devise various multiplexing schemes for use with the store buffer pipeline in accordance with the present invention.

In general, data and addresses from store instructions are stored in store buffer pipeline 310 prior to writing the data into memory system 270. By keeping the data in store buffer pipeline 310 for one or more clock cycles prior to writing the data into memory system 270, various dependency problems can be resolved. For example, data cache 274 can determine whether a cache hit or cache miss for data in store buffer pipeline 310. If a cache miss occurs, data cache 274 can make space available for the data prior to moving the data into memory system 270. Another benefit of placing data in store buffer pipeline 310 is that various forwarding paths (not shown) can be used to pass data from store buffer pipeline 310 to various stages of other pipelines, such as load/store pipeline 300 or integer pipeline 120. In addition, store buffer pipeline 310 allows for the addition of forwarding passes from various pipeline stages into store buffer pipeline 310. Because, little or no processing of data is performed in store buffer pipeline 310, the data in store buffer pipeline 310 are available for most of each clock cycle. Thus data forwarded from store buffer 310 can easily be processed by the stages receiving the forwarded data within the required clock cycle. Similarly, because little or no processing of incoming data is performed by the store buffer stages, data can be forwarded into store buffer pipeline 310 late in the clock cycle. Thus, the additional forwarding paths can be used to resolve various data dependency problems.

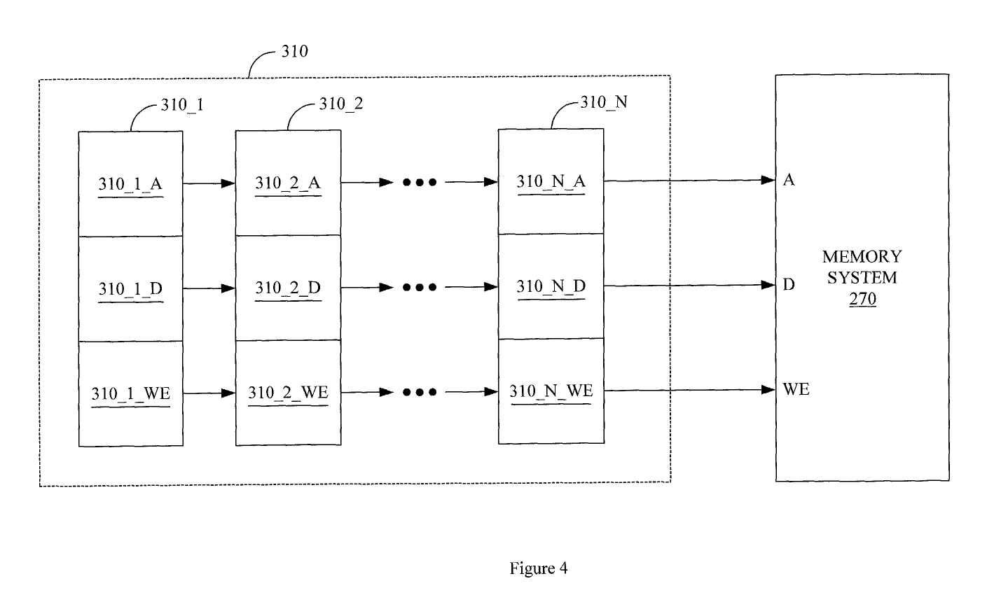

FIG. 4 is a simplified block diagram of one embodiment of store buffer pipeline 310 coupled to memory system 270. In the embodiment FIG. 4, store buffer 310 includes N store buffer stages 310_1, 310_2, . . . 310_N. Each store buffer stage 310_X includes an address portion 310_X_A, a data portion 310_X_D, and a byte write enable portion 310_X_WE, where X is an integer from 1 to N. Address portion 310_X_A is used to store the address used in a store instruction. Data portion 310_X_D stores the data that should be stored at the address in address portion 310_X_A. Byte write enable portion 310_X_WE are used to enable various bytes of memory system 270. For example if memory system 270 is 64 bits wide, i.e. 8 bytes byte write enable portion 310_X_WE would include 8 bits, which are used to enable data to be written to a corresponding byte of memory system 270. Furthermore, some embodiments of the present invention includes multiple bank of memories which can be addressed independently. For these embodiments, address portion 310_X_A can store and address for each bank of memory. For example, one embodiment of the present invention includes 8 banks of memory each being one byte wide. Each bank can be individually addressed and enabled. Thus, address portion 310_X_A would contain eight addresses and byte write enable portion 310_X_WE would contain eight byte write enable signals.

In general, data, address, and byte write enables in a store buffer stage 310_X is eventually transferred to store buffer stage 310_X+1, for X less than N. Thus, each store buffer stage 310_X is coupled to store buffer stage 310_X+1, for X less than N. Data in data portion 310_N_D of store buffer stage 310_N is eventually transferred to the memory address stored in address portion 310_N_A of memory system 270 subject to the byte write enables stored in byte write enable portion 310_N_WE. Thus, address portion 310_N_A is coupled to address terminals A of memory system 270, data portion 310_N_D is coupled to data terminals D of memory system 270, and byte write enable portion 310_N_WE is coupled to the byte write enable terminals WE of memory system 270. In addition various forwarding paths (not shown) from the data buffer stages can be added to various pipeline stages. Furthermore, various bypass paths (not shown in FIG. 4), which are explained below exists in store buffer pipeline 310 to resolve data dependency issues.

The byte write enable signals can also be viewed as valid bits for the store instruction. Cancellation of a store instruction can be accomplished by invalidating the byte write enable signals. Thus, by using the store buffer pipeline 310 to delay the store instructions, cancellation of a store instruction can be easily carried out by invalidating the byte write enable signals in the appropriate byte write enable portion 310_X_WE while the store instruction resides in store buffer pipeline 310.

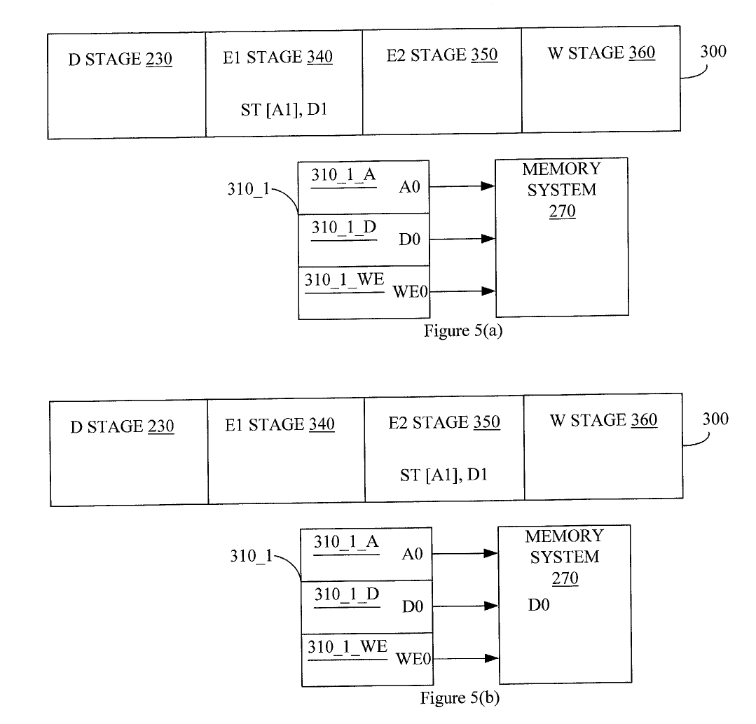

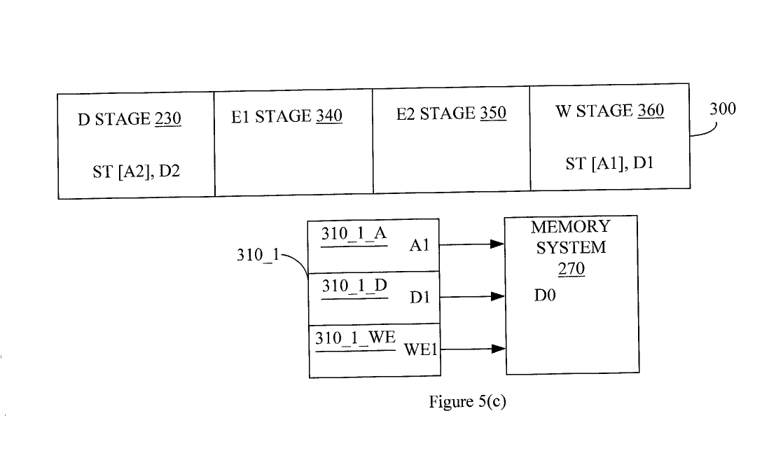

Data transfers in store buffer pipeline 310 are triggered by store instructions in load/store pipeline 310. FIGS. 5(a)-5(c) illustrates the actions of an embodiment of store buffer pipeline 310 having a single store buffer stage. For clarity, FIGS. 5(a)-5(c) show only a single instruction in load/store pipeline 300. In actual use, several instructions are simultaneously processed in load/store pipeline 300. As illustrated in FIG. 5(a), an instruction “ST [A1], D1” is being processed in execute 1 stage 340 and store buffer stage 310_1 contains data D0, address A0, and byte write enables WE0 in data portion 310_1_D, address portion 310_1_A, and byte write enable portion 310_1_WE, respectively. If a store instruction is in execute one stage 340, then at the next active edge of the system clock signal, the data in data portion 310_1_D of store buffer stage 310_1 is written into the memory system 270 using the memory address in address portion 310_1_A subject to the byte write enables in byte write enable portion 310_1_WE. Thus, as illustrated in FIG. 5(b), after the active clock edge data D0 is written into memory system 270 at address A0 subject to byte write enable WED. In addition, instruction “ST [A1], D1” is passed to execute two stage 350.

If a store instruction is in execute two stage 350, the address, data, and write byte enables associated with the store instruction are stored in store buffer stage 310_1 at the next active clock edge of the system clock signal. Thus, as illustrated in FIG. 5(c) after the next active clock edge, address A1, data D1, and byte write enables WE1 from store instruction “ST [A1], D1” are stored in address portion 310_1_A, data portion 310_1_D, and byte write enable portion 310_1_WE, respectively, of store buffer stage 310_1. In addition store instruction “ST [A1], D1” is passed to write back stage 360. Address A1, data D1, and byte write enable WE1 would remain in store buffer stage 310_1 until another store instruction propagates through execute one stage 340.

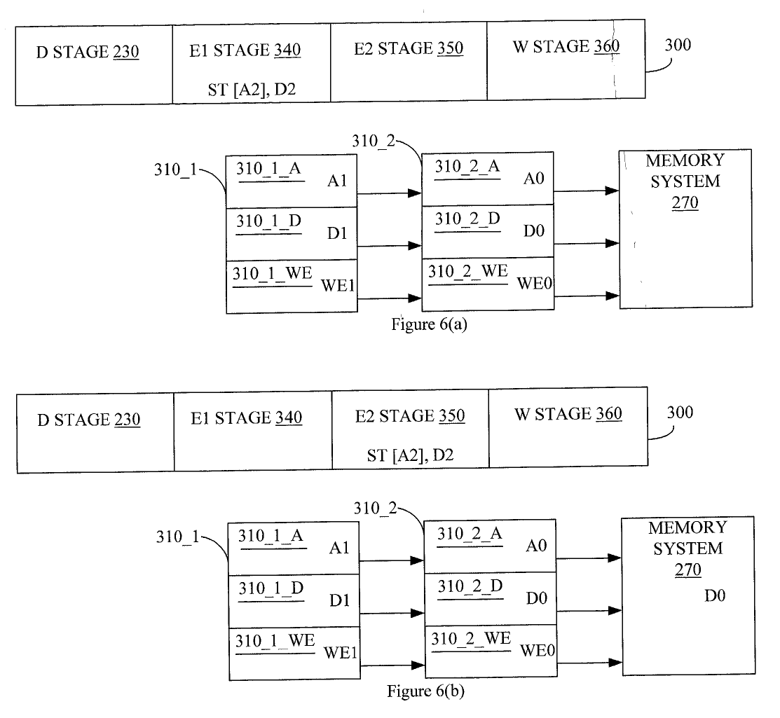

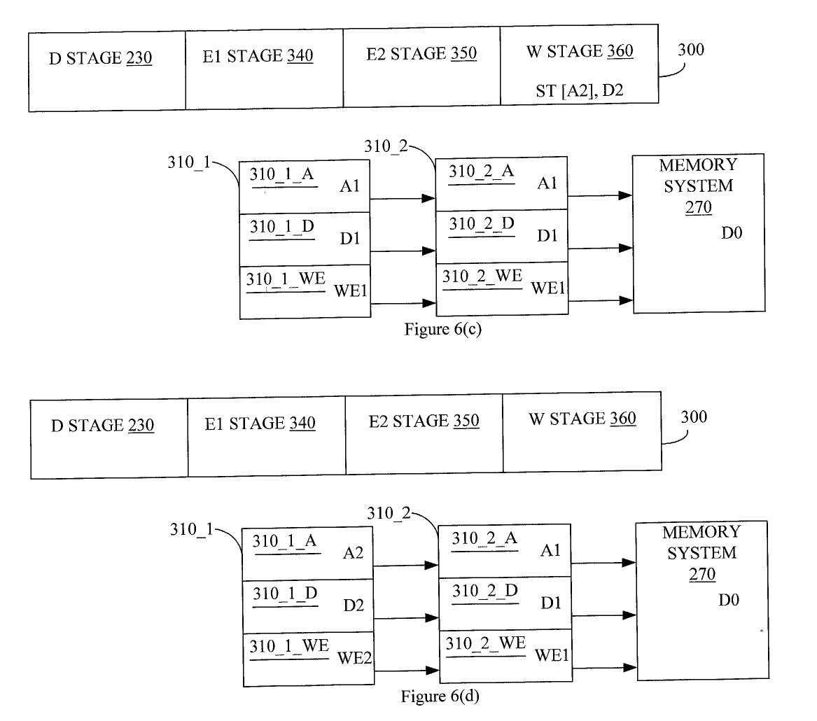

FIGS. 6(a)-6(d) illustrates the actions of an embodiment of store buffer pipeline 310 having a first store buffer stage 310_1 and a second store buffer stage 310_2. For clarity, FIGS. 6(a)-6(d) show only a one instruction in load/store pipeline 300. In actual use, additional instructions can be processed simultaneously in load/store pipeline 300. As illustrated in FIG. 6(a), an instruction “ST [A2], D2” is being processed in execute 1 stage 340. Store buffer stage 310_1 contains data D1, address A1, and byte write enables WE1 in data portion 310_1_D, address portion 310_1_A, and byte write enable portion 310_1_WE, respectively. Store buffer stage 310_2 contains data D0, address A0, and byte write enables WE0 in data portion 310_2_D, address portion 310_2_A, and byte write enable portion 310_2_WE, respectively. If a store instruction is in execute one stage 340, then at the next active edge of the system clock signal, the data in data portion 310_2_D of store buffer stage 310_2 is written into the memory system 270 using the memory address in address portion 310_2_A subject to the byte write enables in byte write enable portion 310_2_WE. Thus, as illustrated in FIG. 6(b), after the next active clock edge data D0 is written into memory system 270 at address A0 subject to byte write enable WE0. In addition, instruction “ST [A2], D2” is passed to execute two stage 350.

If a store instruction is in execute two stage 350, the address, data, and write byte enables of store buffer stage 310_1 are copied into store buffer stage 310_2 at the next active clock edge of the system clock signal. Thus, as illustrated in FIG. 6(c) after the next active clock edge, address A1, data D1, and byte write enables WE1 from store buffer stage 310_1 are copied to store buffer stage 310_2. In addition store instruction “ST [A2], D2” is passed to write back stage 360.

If a store instruction is in write back stage 360, the address, data, and write byte enables associated with the store instruction are stored in store buffer stage 310_1 at the next active clock edge of the system clock signal. Thus, as illustrated in FIG. 6(d) after the next active clock edge, address A2, data D2, and byte write enables WE2 from store instruction “ST [A2], D2” are stored in address portion 310_1_A, data portion 310_1_D, and byte write enable portion 310_1_WE, respectively, of store buffer stage 310_1. Address A2, data D2, and byte write enable WE2 would remain in store buffer stage 310_1 until another store instruction propagates through execute two stage 350.

If the stages of load/store pipeline 300 were numbered zero for decode stage 230, one for execute one stage 340, two for execute two stage 350, and three for write back stage 360. In addition, additional stages following write back stage 360 are numbered consecutively starting with four, three general rules would describe the process of using embodiments of store buffer pipeline 310 having N stages. First, if a store instruction is in load/store pipeline stage one (i.e., execute one stage 340) then at the next active edge of the system clock signal, the oldest valid data in a data portion 310_X_D of store buffer pipeline and load/store pipeline stage N+1 is written into the memory system 270 using the memory address in address portion 310_N_A subject to the byte write enables in byte write enable portion 310_N_WE. In general, data in a store buffer stage remains valid until the data is copied to another store buffer stage or to memory system 270. Various method can be used to track the validity of the data. For example, in one embodiment a valid bit is associated with each store buffer stage whenever data is copied or moved from a store buffer stage the associated bit is set to an invalid state. Conversely, whenever data is written into a store buffer stage, the associated bit is set to a valid state. In general, valid data in a data portion 310_X_D is older than valid data in a data portion 30_Y_D, if X is greater than Y. Furthermore, all valid data in store buffer pipeline 310 is older than valid data in load/store pipeline stage N+1.

Second, if a store instruction is in a load/store pipeline stage S (where S is greater than 1 and less than N) and the data in store buffer stage 310_N−S is valid, the contents of store buffer stage 310_N−S is transferred to store buffer stage 310_N−S+1 at the next active edge of the system clock signal unless the first rule causes the data in buffer stage 310_N−S+1 to be moved into memory system 270. Third, if a store instruction is in load/store pipeline stage N+1, the address, data, and write byte enables associated with the store instruction are stored in store buffer stage 310_M at the next active clock edge of the system clock signal unless the first rule causes the data in load/store pipeline stage N+1 to be moved into memory system 270, where 310_M refers to the store buffer stage having the largest value for M and not containing valid data. For example, if only store buffer stages 310_1 and 310_2 do not contain valid data, store buffer stage 310_M would be store buffer stage 310_2.

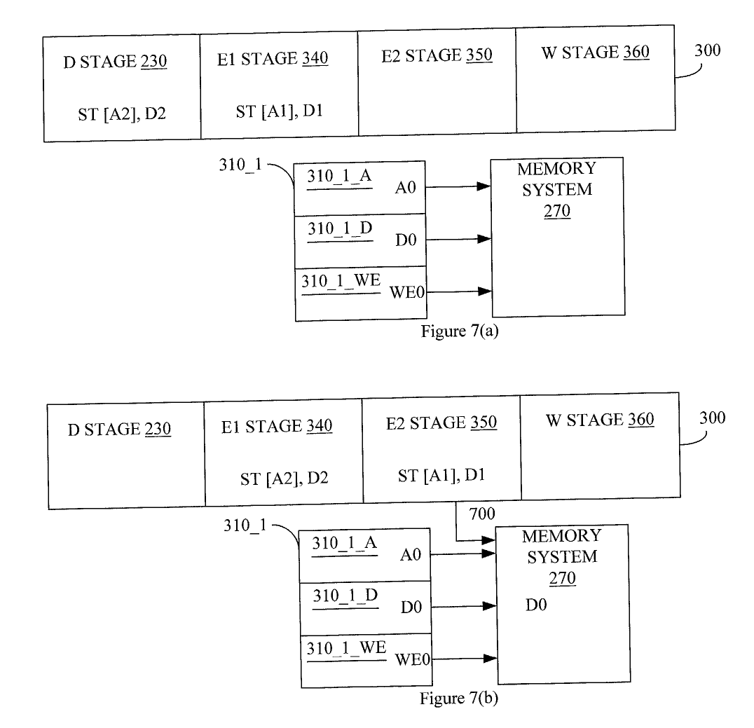

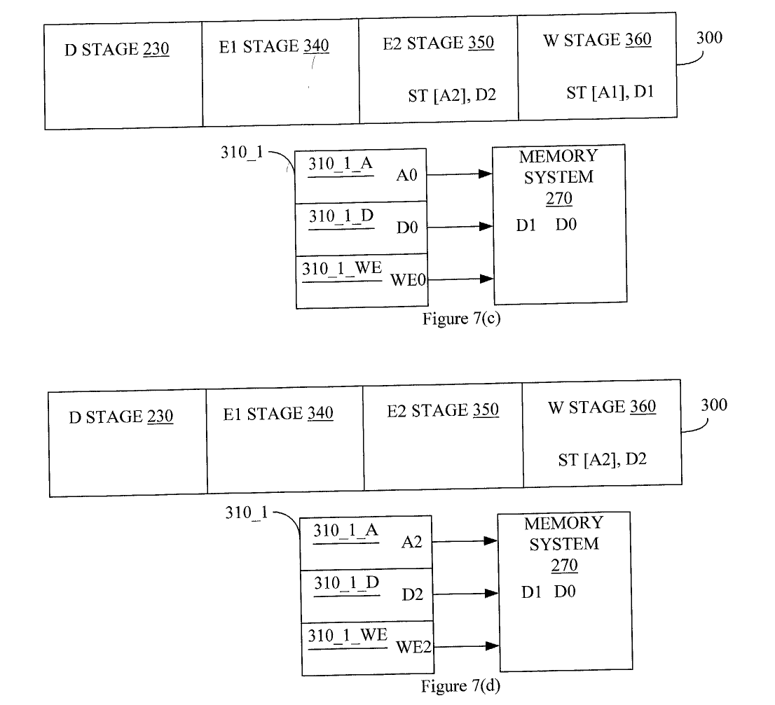

To implement the general rules, bypass paths are needed when if two or more store instructions are issued consecutively into load/store pipeline 300. FIGS. 7(a)-7(d) illustrates the use of a bypass path to implement the general rules for an embodiment of store buffer pipeline 310 having a single store buffer stage 310_1. As illustrated in FIG. 7(a), an instruction “ST [A1], D1” is being processed in execute 1 stage 340, instruction “ST [A2], D2” is being processed in decode stage 230, and store buffer stage 310_1 contains data D0, address A0, and byte write enables WE0 in data portion 310_1_D, address portion 310_1_A, and byte write enable portion 310_1_WE, respectively. As explained above, if a store instruction is in execute one stage 340, then at the next active edge of the system clock signal, the data in data portion 310_1_D of store buffer stage 310_1 is written into the memory system 270 using the memory address in address portion 310_1_A subject to the byte write enables in byte write enable portion 310_1_WE. Thus, as illustrated in FIG. 7(b), after the active clock edge data D0 is written into memory system 270 at address A0 subject to byte write enable WE0 and the data in store buffer stage 310_1 becomes invalid. In addition, instruction “ST [A1], D1” is passed to execute two stage 350 and instruction “ST [A2], D2” is passed to execute one stage 340.

As explained above, the second rule states that if a store instruction is in execute two stage 350, the address, data, and write byte enables associated with the store instruction should be stored in store buffer stage 310_1 at the next active clock edge of the system clock signal. However, the first rule overrules the second rule because a store instruction is in execute one stage 340 and the data in store buffer stage 310_1 is invalid. Thus, in the situation illustrated in FIG. 7(b) where store instruction “ST [A2], D2” is in execute one stage 340, store instruction “ST [A1], D1” is in execute two stage 350, and store buffer stage 310 contains invalid memory, a bypass path 710 is used to directly write data D1 into memory system 270 from execute two stage 350. Multiplexers (not shown) are usually used to couple bypass path 710 to memory system 270.

Thus, as illustrated in FIG. 7(c) after the next active clock edge, data D1 is in memory system 270 at address A1 subject to byte write enables WE1. In addition store instruction “ST [A1], D1” is passed to write back stage 360 and instruction “ST [A2], D2” is passed to execute two stage 350. As illustrated in FIG. 7(d) after the next clock cycle, address A2, data D2, and byte write enables WE2 from store instruction “ST [A2], D2” are stored in address portion 310_1_A, data portion 310_1_D, and byte write enable portion 310_1_WE, respectively, of store buffer stage 310_1. In addition store instruction “ST [A2], D2” is passed to write back stage 360. Address A2, data D2, and byte write enable WE2 would remain in store buffer stage 310_1 until another store instruction propagates through execute one stage 340.

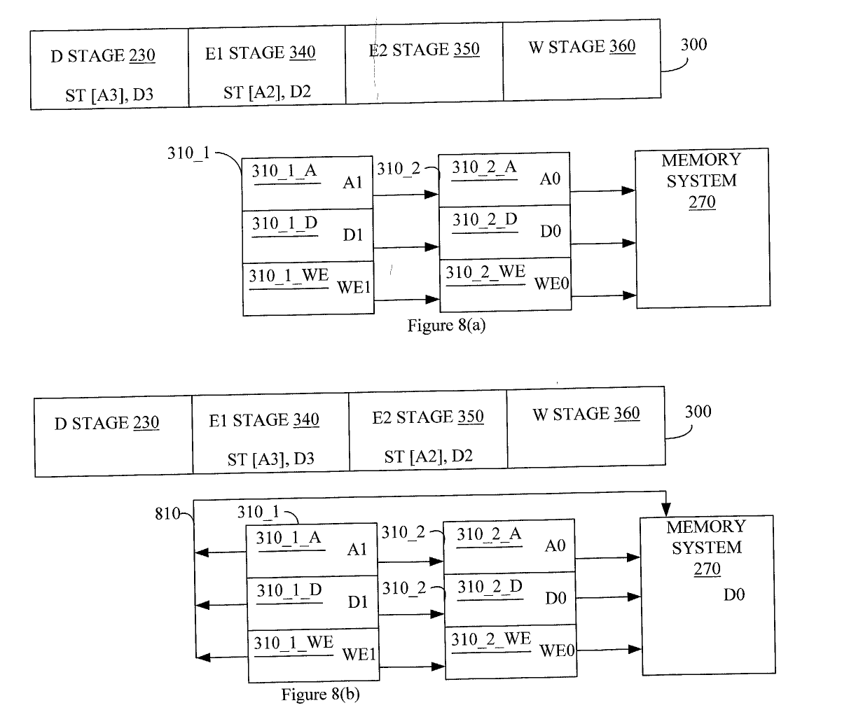

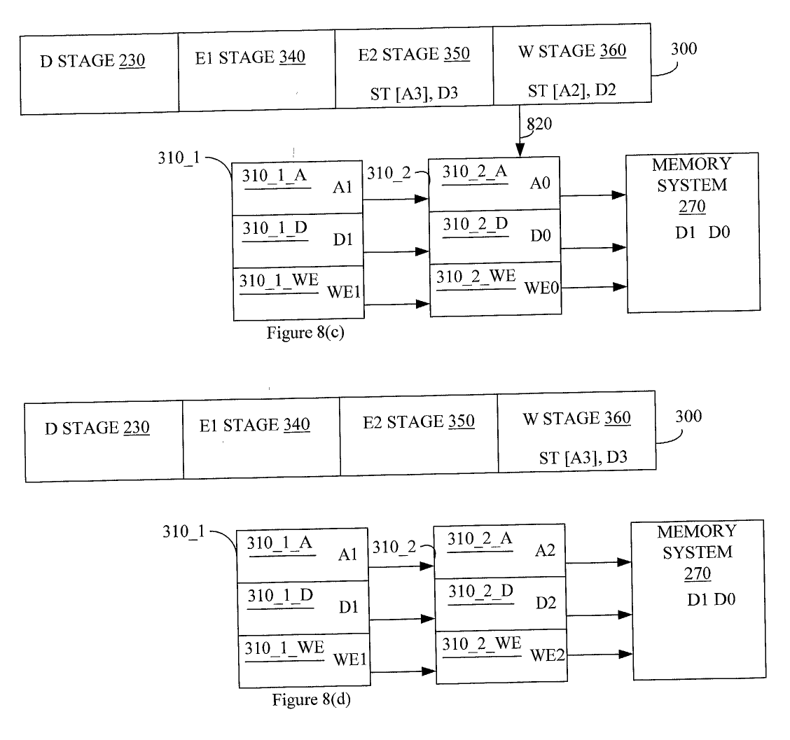

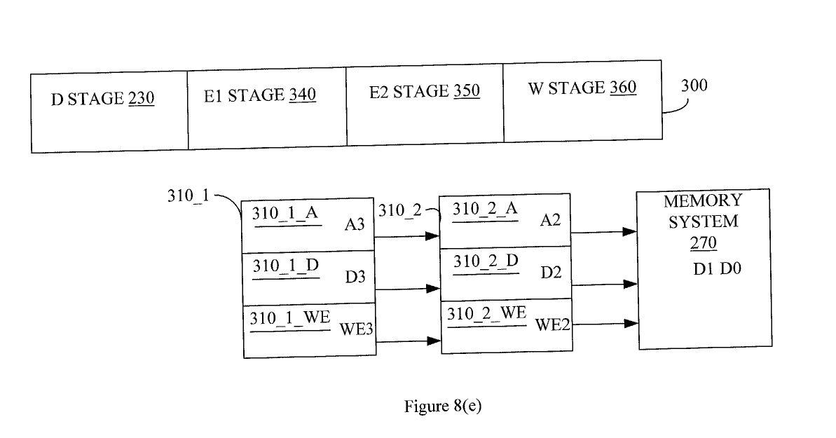

FIGS. 8(a)-8(e) illustrates the use of bypass paths to implement the general rules for an embodiment of store buffer pipeline 310 having a first store buffer stage 310_1 and a second store buffer stage 310_2. As illustrated in FIG. 8(a), an instruction “ST [A2], D2” is being processed in execute 1 stage 340 and an instruction “ST [A3], D3” is being processed in decode stage 230. Store buffer stage 310_1 contains data D1, address A1, and byte write enables WE1 in data portion 310_1_D, address portion 310_1_A, and byte write enable portion 310_1_WE, respectively. Store buffer stage 310_2 contains data D0, address A0, and byte write enables WE0 in data portion 310_2_D, address portion 310_2_A, and byte write enable portion 310_2_WE, respectively. If a store instruction is in execute one stage 340, then at the next active edge of the system clock signal, the data in data portion 310_2_D of store buffer stage 310_2 is written into the memory system 270 using the memory address in address portion 310_2_A subject to the byte write enables in byte write enable portion 310_2_WE. Thus, as illustrated in FIG. 8(b), after the next active clock edge data D0 is written into memory system 270 at address A0 subject to byte write enable WE0, which invalidate the data in store buffer stage 310_2. In addition, instruction “ST [A2], D2” is passed to execute two stage 350 and instruction “ST [A3], D3” is passed to execute one stage 340.

According to the second rule, if a store instruction is in execute two stage 350, the address, data, and write byte enables of store buffer stage 310_1 should be copied into store buffer stage 310_2 at the next active clock edge of the system clock signal. However, the second rule is overruled by the first rule because a store instruction is in execute one stage 440 and data in store buffer stage 310_2 is invalid. Thus, in the situation illustrated in FIG. 8(b) where store instruction “ST [A3], D3” is in execute one stage 340, store instruction “ST [A2], D2” is in execute two stage 350, and data in store buffer stage 310_2 is invalid, a bypass path 810 is used to directly write data D1 into memory system 270 from store buffer stage 310_1, which invalidates the data in store buffer stage 310_1. Multiplexers (not shown) are usually used to couple bypass path 810 to memory system 270.

Thus, as illustrated in FIG. 8(c) after the next active clock edge, data D1 is stored in memory system 270 at address A1 subject to byte write enables WE1. In addition store instruction “ST [A2], D2” is passed to write back stage 360 and instruction “ST [A3], D3” is passed to execute two stage 350.

According to rule 3, if a store instruction is in write back stage 360, the address, data, and write byte enables associated with the store instruction should be stored in store buffer stage 310_2 at the next active clock edge of the system clock signal because neither store buffer stages 310_1 or store buffer stage 310_2 contains valid data. Because store buffer 310_1 does not contain valid data, rule two does not apply even though store instruction “ST [A3], D3” is in execute two stage 350. Thus, in the situation illustrated in FIG. 8(c) where store instruction “ST [A3], D3” is in execute two stage 350, store instruction “ST [A2], D2” is in write back stage 360, store buffer 310_1 and store buffer 310_2 both contain invalid data, a bypass path 820 is used to directly write address A2, data D2, and byte write enables WE2 into store buffer stage 310_2 from write back stage 360. Multiplexers (not shown) are usually used to couple bypass path 820 to store buffer stage 310_2.

Thus, as illustrated in FIG. 8(d) after the next active clock edge, address A2, data D2, and byte write enables WE2 from store instruction “ST [A2], D2” are stored in address portion 310_2_A, data portion 310_2_D, and byte write enable portion 310_2_WE, respectively, of store buffer stage 310_2. In addition, store instruction “ST [A3], D3” passes to write back stage 360. According to the third rule, if a store instruction is in write back stage 360, the address, data, and write byte enables associated with the store instruction should be stored in store buffer stage 310_1 (because store buffer stage 310_2 contains valid data) at the next active clock edge of the system clock signal. Thus, as illustrated in FIG. 8(e) after the next clock cycle, address A3, data D3, and byte write enables WE3 from store instruction “ST [A3], D3” are stored in address portion 310_1_A, data portion 310_1_D, and byte write enable portion 310_1_WE, respectively, of store buffer stage 310_1 Address A3, data D3, and byte write enable WE3 would remain in store buffer stage 310_1 until another store instruction propagates through execute one stage 340. Similarly, address A2, data D2, and byte write enable WE2 would remain in store buffer stage 310_2 until another store instruction propagates through execute two stage 350.

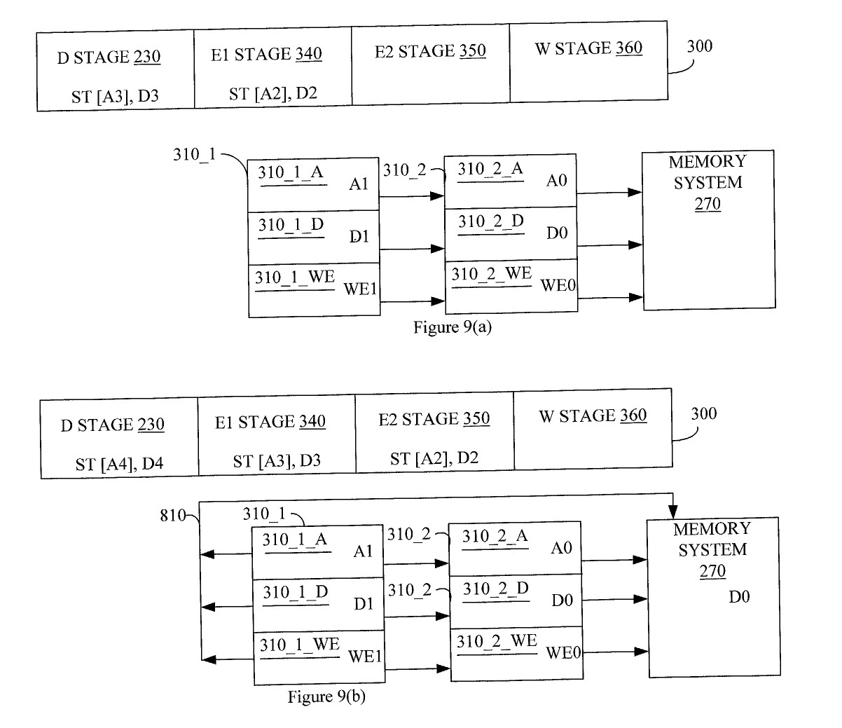

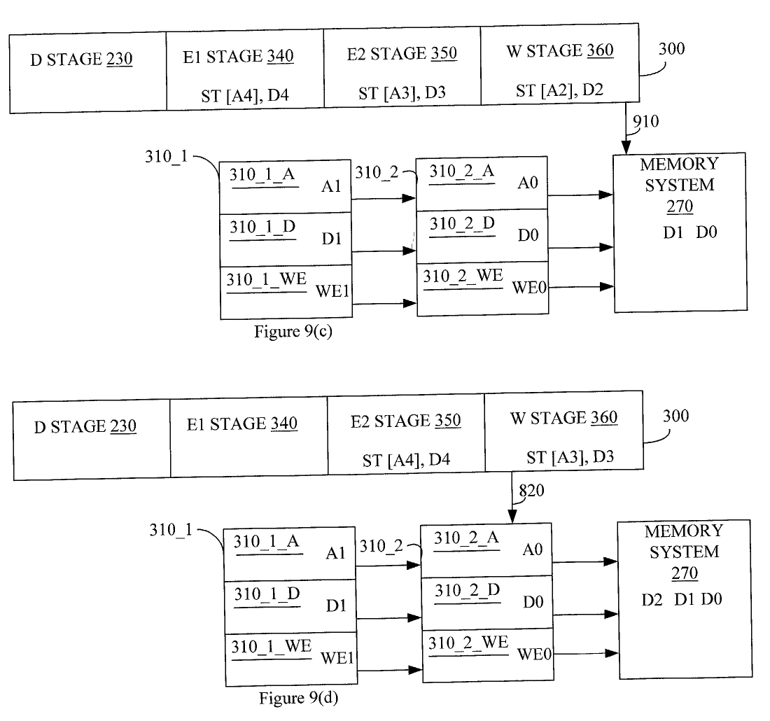

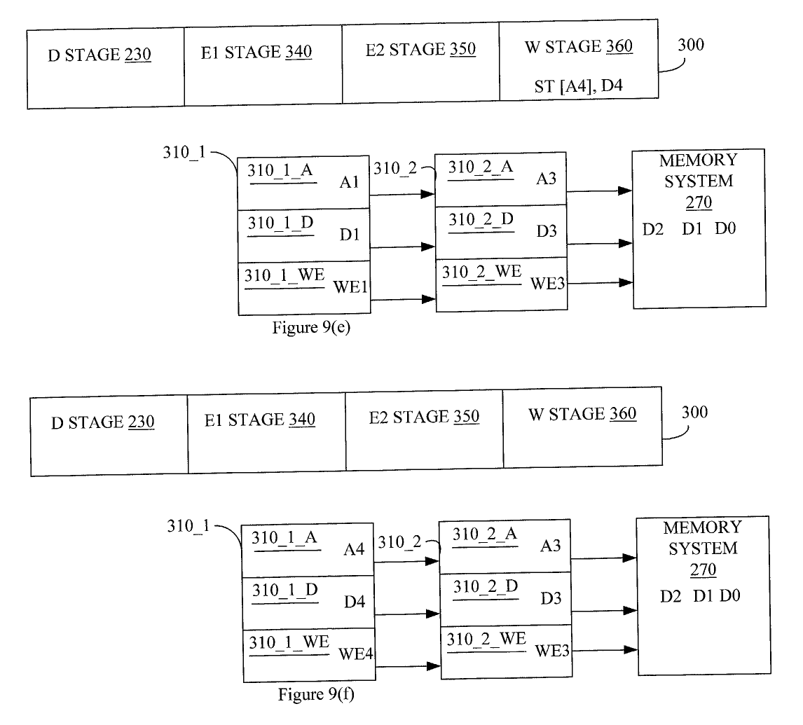

When three or more consecutive store instructions are issued into load/store pipeline 300, an additional bypass path is required. FIGS. 9(a)-9(f) illustrate the use of bypass paths to implement the general rules for an embodiment of store buffer pipeline 310 having a first store buffer stage 310_1 and a second store buffer stage 310_2. As illustrated in FIG. 9(a), an instruction “ST [A2], D2” is being processed in execute 1 stage 340 and an instruction “ST [A3], D3” is being processed in decode stage 230. Store buffer stage 310_1 contains data D1, address A1, and byte write enables WE1 in data portion 310_1_D, address portion 310_1_A, and byte write enable portion 310_1_WE, respectively. Store buffer stage 310_2 contains data D0, address A0, and byte write enables WE0 in data portion 310_2_D, address portion 310_2_A, and byte write enable portion 310_2_WE, respectively. If a store instruction is in execute one stage 340, then at the next active edge of the system clock signal, the data in data portion 310_2_D of store buffer stage 310_2 is written into the memory system 270 using the memory address in address portion 310_2_A subject to the byte write enables in byte write enable portion 310_2_WE. Thus, as illustrated in FIG. 9(b), after the next active clock edge data D0 is written into memory system 270 at address A0 subject to byte write enable WE0, which also invalidates the data in store buffer stage 310_1. In addition, instruction “ST [A2], D2” is passed to execute two stage 350 and instruction “ST [A3], D3” is passed to execute one stage 340. Furthermore, an instruction “ST [A4], D4” is issued into decode stage 230.

According to the second rule, if a store instruction is in execute two stage 350, the address, data, and write byte enables of store buffer stage 310_1 should be copied into store buffer stage 310_2 at the next active clock edge of the system clock signal. However, the second rule is overruled by the first rule because a store instruction is in execute one stage 440 and data in store buffer stage 310 2 is invalid. Thus, in the situation illustrated in FIG. 9(b) where store instruction “ST [A3], D3” is in execute one stage 340, store instruction “ST [A2], D2” is in execute two stage 350, and data in store buffer stage 310_2 is invalid, a bypass path 810 is used to directly write data D1 into memory system 270 from store buffer stage 310_1, which invalidates the data in store buffer stage 310_1. Multiplexers (not shown) are usually used to couple bypass path 810 to memory system 270.

Thus, as illustrated in FIG. 8(c) after the next active clock edge, data D1 is stored in memory system 270 at address A1 subject to byte write enables WE1. In addition store instruction “ST [A2], D2” is passed to write back stage 360,instruction “ST [A3], D3” is passed to execute two stage 350, and store instruction “ST [A4], D4” is passed to execute one stage 340.

According to the third rule, if a store instruction is in write back stage 360, the address, data, and write byte enables associated with the store instruction should be stored in store buffer stage 310_M at the next active clock edge of the system clock signal. However, the first rule overrules the third rule, because a store instruction is in execute one stage 340 and neither store buffers 310_1 or 310_2 contain valid data. The second rule does not apply since store buffer 310_1 does not contain valid data. Thus, in the situation illustrated in FIG. 8(c) where store instruction “ST [A3], D3” is in execute two stage 350, store instruction “ST [A2], D2” is in write back stage 360, store instruction “ST [A4] D4” is in execute one stage 340, and neither store buffer 310_1 or store buffer 310_2 contains valid data, a bypass path 910 between write back stage 360 and memory system 270 is used to directly write data D2 into memory system 270 at address A2 subject to byte write enables WE2. Multiplexers (not shown) are usually used to couple bypass path 910 to memory system 270.

Thus, as illustrated in FIG. 9(d) after the next active clock edge, data D2 is in memory system 270 at address A2 subject to byte write enables WE2. In addition, store instruction “ST [A3], D3” passes to write back stage 360 and store instruction “ST [A4], D4]” passes to execute two stage 350. According to rule 3, if a store instruction is in write back stage 360, the address, data, and write byte enables associated with the store instruction should be stored in store buffer stage 310_2 at the next active clock edge of the system clock signal because neither store buffer stages 310_1 or store buffer stage 310_2 contains valid data. Because store buffer 310_1 does not contain valid data, rule two does not apply even though store instruction “ST [A4], D4” is in execute two stage 350. Thus, in the situation illustrated in FIG. 9(d) where store instruction “ST [A4], D4” is in execute two stage 350, store instruction “ST LA3], D3” is in write back stage 360, store buffer 310_1 and store buffer 310_2 both contain invalid data, a bypass path 820 is used to directly write address A3, data D3, and byte write enables WE3 into store buffer stage 310_2 from write back stage 360. Multiplexers (not shown) are usually used to couple bypass path 820 to store buffer stage 310_2.

Thus, as illustrated in FIG. 9(e) after the next active clock edge, address A3, data D3, and byte write enables WE3 from store instruction “ST [A3], D3” are stored in address portion 310_2_A, data portion 310_2_D, and byte write enable portion 310_2_WE, respectively, of store buffer stage 310_2. In addition, store instruction “ST [A4], D4” passes to write back stage 360.

According to the third rule, if a store instruction is in write back stage 360, the address, data, and write byte enables associated with the store instruction should be stored in store buffer stage 310_1 (because store buffer stage 310_2 contains valid data) at the next active clock edge of the system clock signal. Thus, as illustrated in FIG. 9(f) after the next clock cycle, address A4, data D4, and byte write enables WE4 from store instruction “ST [A4], D4” are stored in address portion 310_1_A, data portion 310_1-D, and byte write enable portion 310_1_WE, respectively, of store buffer stage 310_1 Address A4, data D4, and byte write enable WE4 would remain in store buffer stage 310_1 until another store instruction propagates through execute one stage 340. Similarly, address A3, data D3, and byte write enable WE3 would remain in store buffer stage 310_2 until another store instruction propagates through execute two stage 350.

As explained above, data forwarding can be used to avoid many data dependency issues. Store buffer pipeline 310 facilitates data forwarding because store buffer pipeline keeps recently stored data easily available for several clock cycles. Furthermore, the store buffer stages usually perform little or no processing on the data. Therefore, the data in the store buffer stages can be forwarded early in each clock cycle. Similarly, because the store buffer stages usually perform little or no processing on the data, data can be forwarded to the store buffer pipeline late in each clock cycle. Depending on the architecture of the microprocessor, almost any type and topology of forwarding paths can be used with store buffer pipeline 310.

The addition of store buffer pipeline 310 to an load/store pipeline adds some complexity to the processing of load instructions. In a typical load/store pipeline, execute two stage 250 must determine whether the valid (i.e. most recent) value for a memory address resides in the memory system or in a pipeline stage. However with the addition of load/store pipeline 310, execute two stage 350 must determine whether the most valid value for a memory address is in the memory system, other pipeline stages, or in one of the store buffer stages. Conventional memory management techniques can be used by treating the store buffer stages as caches to find valid values for memory addresses.

Another benefit of using a store buffer pipeline with a load/store pipeline in accordance with embodiments of the present invention is the elimination of many resource conflicts between load and store instructions. As explained above, in conventional load/store pipelines a load instruction configures the system memory in execute one stage 240 and the memory provides data when the load instruction is in execute two stage 250. However, in conventional memory systems, store instructions configures memory system 270 in execute two stage 250 and the memory stores data when the store instruction is in write back stage 260. If a store instruction is followed by a load instruction in load/store pipeline 200, the store instruction would be processed in write back stage 260 at the same time that the load instruction is processed by execute two stage 250. Thus, in conventional load/store pipelines, both execute two stage 250 and write back stage 260 requires the use of memory system 270 to finish processing the instructions. Because, memory system 270 generally can not be used for reading and writing simultaneously, a pipeline stall occurs. In accordance with embodiments of the present invention, memory system 270 stores data at the next active edge of the clock cycle when a store instruction is in execute one stage 350. Thus, if a store instruction is followed by a load instruction in a load/store pipeline using a store buffer pipeline in accordance with embodiments of the present invention, the store and load instruction would require memory system 270 at different clock edges. Accordingly, memory system 270 can satisfy the requirements of the store and load instruction without causing a pipeline stall.

In the various embodiments of this invention, novel structures and methods have been described to improve the performance of load/store pipelines. By using a store buffer pipeline with a load/store pipeline in accordance with an embodiment of the present invention, common cache coherency hazards and data coherency hazards can be avoided. The various embodiments of the structures and methods of this invention that are described above are illustrative only of the principles of this invention and are not intended to limit the scope of the invention to the particular embodiments described. For example, in view of this disclosure, those skilled in the art can define other instruction fetch stages, pre-decode stages, decode stages, execute stages, store buffer stages, write back stages, forwarding paths, bypath paths, instruction pipelines, load/store pipelines, integer pipelines, instructions, and so forth, and use these alternative features to create a method or system according to the principles of this invention. Thus, the invention is limited only by the following claims.

What is claimed is:

1. A memory loading and storing system comprising:
a load/store pipeline having a first load/store stage and a second load/store stage;
a memory system; and
a store buffer pipeline having a final store buffer stage for storing an address and a data value and coupled between the load/store pipeline and the memory system, wherein the store buffer pipeline is configured to write data from the final store buffer stage into the memory system when a first store instruction transitions from the first load/store stage to the second load/store stage.

2. The memory loading and storing system of claim 1, wherein the load/store pipeline further comprises a third load/store stage and wherein the load/store pipeline is configured to write data from a second store instruction into the final store buffer stage when the second store instruction transitions from the second load/store stage to the third load/store stage.

3. The memory loading and storing system of claim 1, further comprising a bypass path between the third load store pipeline and the memory system.

4. The memory loading and storing system of claim 1, wherein the final store buffer stage comprises a data portion, an address portion, and a byte write enable portion.

5. The memory loading and storing system of claim 1, wherein the store buffer pipeline further comprises a first store buffer stage coupled to the load/store pipeline and the final store buffer stage.

6. The memory loading and storing system of claim 5, further comprising a bypass path between the first store buffer stage and the memory system.

7. The memory system of claim 5, wherein the load/buffer pipeline further comprises a third load/store stage.

8. A method of storing data into a memory system using a store buffer pipeline and a load/store pipeline having a first load/store stage and a second load store stage, the method comprising:
processing a first store instruction in the load/store pipeline;
storing data from the first store instruction in the store buffer pipeline; and
copying the data from the first store instruction from the store buffer pipeline into the memory system as a second store instruction transitions from the first load/store stage to the second load store stage.

9. The method of claim 8, further comprising storing a memory address in the store buffer pipeline.

10. The method of claim 8, further comprising storing a plurality of memory addresses in the store buffer pipeline.

11. The method of claim 8, further comprising storing data from the second store instruction into the store buffer pipeline.
